(19) United States
(12) Patent Application Publication
(10) Pub. No.: US 2025/0367681 A1
(43) Pub. Date: Dec. 4, 2025

(54) IONIZER AND AIR CONDITIONER EQUIPPED WITH SAME

(71) Applicant: Samsung Electronics Co., Ltd., Suwon-si (KR)

(72) Inventors: Sangmo KANG, Suwon-si (KR); Geunyeong PARK, Suwon-si (KR); Soyoung YUN, Suwon-si (KR); Sekwan JEONG, Suwon-si (KR); Youngchul KO, Suwon-si (KR); Dongwoo WOO, Suwon-si (KR)

(21) Appl. No.: 19/300,243

(22) Filed: Aug. 14, 2025

Related U.S. Application Data
(63) Continuation of application No. PCT/KR2024/002117, filed on Feb. 15, 2024.

(30) Foreign Application Priority Data
Mar. 21, 2023 (KR) 10-2023-0036869

(51) Int. Cl. B03C 3/41; B03C 3/12; B03C 3/36; B03C 3/68; F24F 8/30

(52) U.S. Cl. CPC B03C 3/41; B03C 3/12; B03C 3/368; B03C 3/68; F24F 8/30; B03C 2201/10

(57) ABSTRACT

An ionizer includes: a carbon brush; a gate electrode installed around the carbon brush; a power supply electrically connected to the carbon brush and the gate electrode; and at least one processor, comprising processing circuitry, individually and/or collectively, configured to control the power supply to apply power to the carbon brush or the gate electrode. The gate electrode is disposed at the same level as or lower than an upper end of the carbon brush.

### CROSS-REFERENCE TO RELATED APPLICATIONS

This application is a continuation of International Application No. PCT/KR2024/002117 designating the United States, filed on Feb. 15, 2024, in the Korean Intellectual Property Receiving Office and claiming priority to Korean Patent Application No. 10-2023-0036869, filed on Mar. 21, 2023, in the Korean Intellectual Property Office, the disclosures of each of which are incorporated by reference herein in their entireties.

### BACKGROUND

### Field

The disclosure relates to an ionizer and an air conditioner having the same, and for example, to an ionizer using a carbon brush and an air conditioner having the same.

### Description of Related Art

An ionizer and a dust collector are used to remove aerosols, such as contaminants contained in a fluid such as air.

The ionizer according to the prior art includes a carbon brush. The ionizer according to the prior art is configured so that ions are generated at the tip of the carbon brush when a high voltage is applied to the carbon brush. Therefore, when the ionizer operates, the aerosols contained in the air may be charged positively (+) or negatively (−).

The aerosols charged by the ionizer may be attached to the dust collecting plate of the duct collector charged with the opposite polarity, so that the aerosols may be removed from the air.

### SUMMARY

According to an example embodiment of the disclosure, an ionizer may include: a carbon brush; a gate electrode disposed about the carbon brush; a power supply electrically connected to the carbon brush and the gate electrode; and at least one processor, comprising processing circuitry, individually and/or collectively, configured to control the power supply to: apply power to the carbon brush or the gate electrode wherein the gate electrode may be disposed at a same height as or lower than an upper end of the carbon brush.

The carbon brush may be disposed at a center of the gate electrode. The gate electrode may be formed as a closed loop.

The gate electrode may be formed in a ring shape or a regular polygonal shape. The gate electrode may include a plurality of gate electrode parts surrounding the carbon brush. Gaps between the plurality of gate electrode parts may be the same.

The ionizer according to an example embodiment of the disclosure may further include: a brush support configured to support the carbon brush; and a gate support configured to support the gate electrode and provided on an outside of the brush support.

The gate electrode may be provided at a top of the gate support.

A space between the brush support and the gate support may be blocked.

A distance between a tip of the carbon brush and an upper surface of the gate electrode may be at most 50 mm.

A distance between a tip of the carbon brush and an upper surface of the gate electrode may be V0/3000 to 20×V0/3000. V0 may be a voltage applied to the carbon brush or the gate electrode.

The gate electrode may have a rectangular cross-section, and a width of the gate electrode may be 0.1 mm to 10 mm, and a thickness of the gate electrode may be 0.1 mm to 1 mm.

According to an example embodiment of the disclosure, an air conditioner may include: a main body including an air inlet, an air outlet, and an air passage connecting the air inlet and the air outlet; an ionizer according to the above disposed in the air inlet; a dust collector disposed in the air passage of the main body and configured to collect aerosols charged by the ionizer; and an air flow generating device comprising a fan disposed in the air passage of the main body and configured to generate air flow flowing through the air passage.

The ionizer may include a plurality of ionizers arranged in the air inlet.

The ionizer may be disposed so that the carbon brush is parallel to the air flow.

The ionizer may be disposed so that the carbon brush is perpendicular to the air flow.

The air conditioner according to various example embodiments of the disclosure may further include: a treatment device disposed in the air passage of the main body.

### BRIEF DESCRIPTION OF THE DRAWINGS

These and/or other aspects, features, and advantages of certain embodiments of the present disclosure will be more apparent from the following detailed description, taken in conjunction with the accompanying drawings, in which:

FIG. 1 is a perspective view illustrating an example ionizer according to various embodiments;

FIG. 2 is a cross-sectional view illustrating an ionizer according to various embodiments;

FIG. 3 is a diagram illustrating a plan view of an ionizer according to various embodiments;

FIG. 4 is a diagram illustrating a plan view illustrating an ionizer according to various embodiments;

FIG. 5A is a diagram illustrating an example where a gate electrode of an ionizer is triangular according to various embodiments;

FIG. 5B is a diagram illustrating an example where a gate electrode of an ionizer is pentagonal according to various embodiments;

FIG. 5C is a diagram illustrating an example where a gate electrode of an ionizer is hexagonal according to various embodiments;

FIG. 6 is a partial cross-sectional view illustrating an ionizer according to various embodiments;

FIG. 7A is a partial perspective view illustrating an ionizer having a plurality of gate electrodes according to various embodiments;

FIG. 7B is a diagram illustrating a plan view of the ionizer of FIG. 7A according to various embodiments;

FIG. 8 is a diagram illustrating electric field and flow analysis conditions of an ionizer according to various embodiments;

FIG. 9 is a diagram illustrating an electric field distribution around a carbon brush strand of an ionizer according to various embodiments;

FIG. 10 is a graph illustrating the electric field change amount in the vertical axis direction around a carbon brush of an ionizer 1 depending on the surface charge density according to various embodiments;

FIG. 11 is a graph illustrating the electric field change amount in the vertical axis direction around a carbon brush of an ionizer depending on the surface charge density according to the prior art;

FIGS. 12A, 12B, 12C and 12D are diagrams illustrating flow distribution around an ionizer according to the positional relationship between a carbon brush and a gate electrode according to various embodiments;

FIG. 13 is a diagram illustrating an example air conditioner including an ionizer according to various embodiments;

FIG. 14 is a block diagram illustrating an example configuration of an air conditioner including an ionizer according to various embodiments;

FIG. 15 is a diagram illustrating an example air conditioner including an ionizer according to various embodiments;

FIG. 16 is a diagram illustrating a front view of an air conditioner including an ionizer according to various embodiments;

FIG. 17 is a cross-sectional view illustrating the air conditioner of FIG. 16 according to various embodiments;

FIG. 18 is a perspective view illustrating an example ionizer unit of the air conditioner of FIG. 16 according to various embodiments;

FIG. 19 is a perspective view illustrating an indoor unit of an air conditioner in according to various embodiments of the disclosure;

FIG. 20 is a perspective view illustrating a state in which an upper grill is separated from the indoor unit of FIG. 19 according to various embodiments; and

FIG. 21 is an enlarged partial perspective view illustrating a portion A of FIG. 20 according to various embodiments.

### DETAILED DESCRIPTION

Various embodiments of the disclosure and terms used herein are not intended to limit the technical features described in this disclosure to specific embodiments, but should be understood to include various modifications, equivalents, or alternatives of the various embodiments.

In connection with the description of the drawings, similar reference numbers may be used for similar or related components.

The singular form of a noun corresponding to an item may include one or more of the above item, unless the relevant context clearly indicates otherwise.

In this disclosure, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

In addition, terms such as ‘front surface,’ ‘rear surface,’ ‘upper surface,’ ‘lower surface,’ ‘side surface,’ ‘left side,’ ‘right side,’ ‘upper side,’ ‘lower side,’ and the like used in the disclosure may be defined based on the drawings, and forms and locations of each element are not limited by these terms.

Terms such as “include” or “have” are intended to designate the presence of features, numbers, steps, operations, components, parts, or combinations thereof described in the disclosure, but do not preclude the presence or addition of one or more other features, numbers, steps, operations, components, parts, or combination thereof.

When a component is said to be “connected,” “coupled,” “supported,” or “in contact” with another component, this may refer, for example, not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Hereinafter, various example embodiments of an ionizer 1 according to the disclosure will be described in greater detail with reference to the attached drawings.

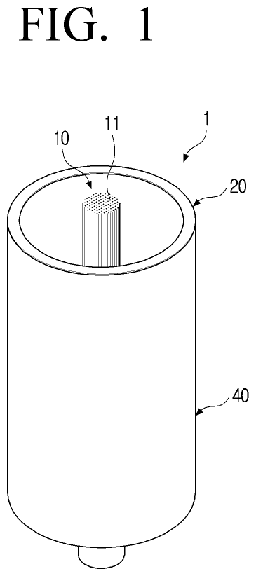

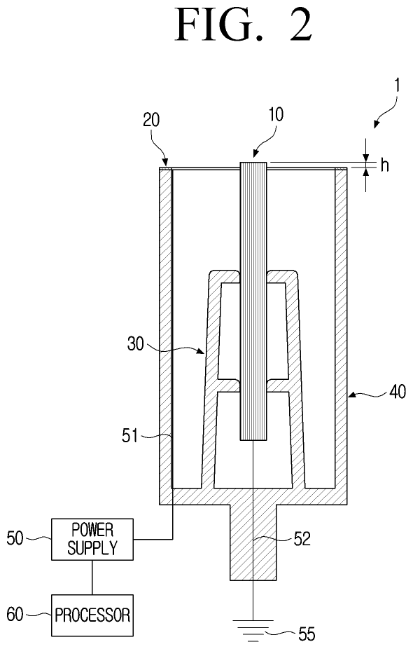

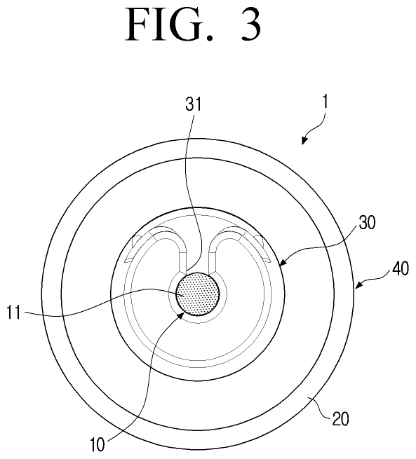

FIG. 1 is a perspective view illustrating an ionizer 1 according to various embodiments. FIG. 2 is a cross-sectional view illustrating an ionizer 1 according to various embodiments. FIG. 3 is a diagram illustrating a plan view of an ionizer 1 according to various embodiments.

Referring to FIGS. 1, 2 and 3 (which may be referred to as FIGS. 1 to 3), an ionizer 1 according to one or more embodiments of the disclosure may include a carbon brush 10, a gate electrode 20, and a power supply 50.

The carbon brush 10 may be configured to emit negative electrons or positive electrons (hereinafter, referred as to ions) from a tip thereof. The carbon brush 10 may be formed of a plurality of carbon fiber strands 11. In other words, the carbon brush 10 may be formed by forming a bundle of the plurality of carbon fiber strands 11 into a brush shape. The plurality of carbon fiber strands 11 may be arranged in a circular shape. The plurality of carbon fiber strands 11 may be spaced apart from each other by a certain distance so as not to contact each other.

The carbon brush 10 may be supported by a brush support 30. The carbon brush 10 may be disposed in the upper end of the brush support 30. A portion of the carbon brush 10 may be accommodated in a receiving recess 31 provided inside the brush support 30, and the remaining portion of the carbon brush 10 may protrude upward from the upper end of the brush support 30.

The brush support 30 may be configured to fix and support the carbon brush 10. The brush support 30 may be formed in an approximately cylindrical shape or an approximately truncated cone shape. The receiving recess 31 in which the carbon brush 10 is accommodated may be provided on the outer circumferential surface of the brush support 30.

The gate electrode 20 may be disposed around the carbon brush 10. The gate electrode 20 may be configured to enhance the electric field applied to the carbon brush 10 to increase an ion emission effect.

The gate electrode 20 may be formed as a closed loop. In the case of this embodiment, the gate electrode 20 may be formed in a ring shape, e.g., a circular shape.

The gate electrode 20 may be formed of a metal. The gate electrode 20 may be formed in a rectangular cross-section. For example, the gate electrode 20 may be formed in a rectangular cross-section having a thin thickness and a wide width. As an example, the width of the gate electrode 20 may be 0.1 mm to 10 mm, and the thickness of the gate electrode 20 may be in 0.1 mm to 1 mm.

However, the cross-sectional shape of the gate electrode 20 may not be limited thereto. The gate electrode 20 may have various cross-sectional shapes as long as it can enhance the electric field between the gate electrode 20 and the carbon brush 10. For example, the gate electrode 20 may be formed to have a circular cross-section, a square cross-section, etc.

The carbon brush 10 may be disposed at the center of the gate electrode 20. Accordingly, the gate electrode 20 may be disposed to surround the entire circumference of the carbon brush 10.

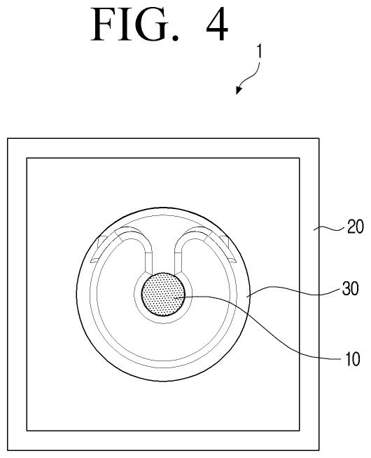

In an embodiment, the gate electrode 20 is formed in a ring shape, but the shape of the gate electrode 20 according to the disclosure may not be limited thereto. The gate electrode 20 according to the disclosure may be formed in various shapes. For example, as illustrated in FIG. 4, the gate electrode 20 may be formed in a square shape.

FIG. 4 is a diagram illustrating a plan view of an ionizer 1 according to various embodiments.

Referring to FIG. 4, the gate electrode 20 may be formed in a square shape. A square space may be formed inside the gate electrode 20. For example, the square gate electrode 20 may be formed by bending a thin strip-shaped metal plate having a narrow width into a square shape. The carbon brush 10 may be disposed at the center of the inside space of the gate electrode 20.

When the square gate electrode 20 is disposed around the carbon brush 10 in this way, the electric field formed between the carbon brush 10 and the gate electrode 20 may not be biased.

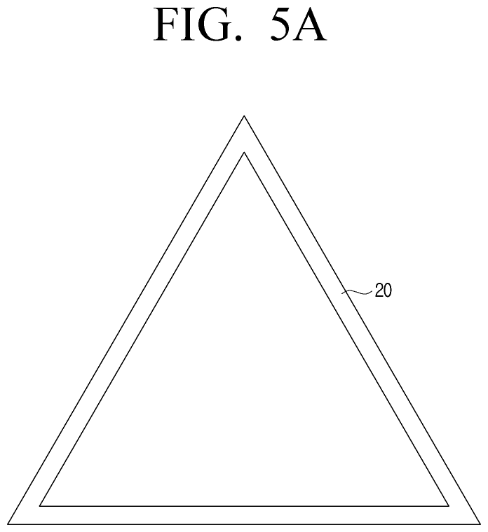

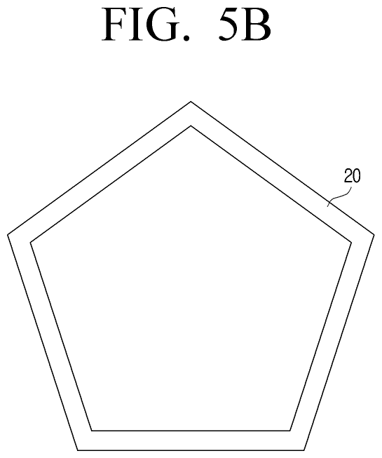

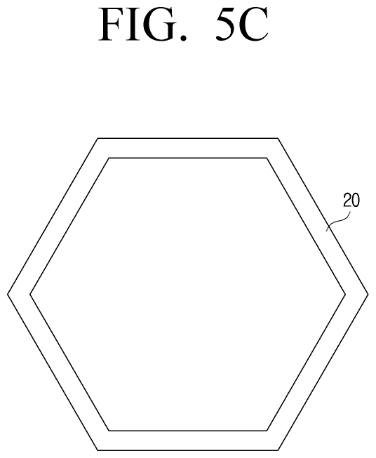

The shape of the gate electrode 20 used in the ionizer 1 according to the disclosure may not be limited thereto. The gate electrode 20 may be formed in a regular polygonal shape. Various examples of the gate electrode 20 are illustrated in FIGS. 5A, 5B, and 5C.

FIG. 5A is a diagram illustrating an example where a gate electrode 20 of an ionizer 1 according to various embodiments is triangular.

Referring to FIG. 5A, the gate electrode 20 may be formed in an equilateral triangle shape. In other words, the gate electrode 20 may include an outer surface of an equilateral triangle shape and an inner surface of an equilateral triangle shape. Accordingly, an equilateral triangle-shaped space may be formed inside the gate electrode 20. The carbon brush 10 may be disposed at the center of the inner space of the gate electrode 20 formed in an equilateral triangle shape.

FIG. 5B is a diagram illustrating an example where a gate electrode 20 of an ionizer 1 according to various embodiments is pentagonal.

Referring to FIG. 5B, the gate electrode 20 may be formed in a regular pentagon. In other words, the gate electrode 20 may include an outer surface of a regular pentagon shape and an inner surface of a regular pentagon shape. Accordingly, a space of a regular pentagon shape may be formed inside the gate electrode 20. The carbon brush 10 may be disposed at the center of the gate electrode 20 formed in a regular pentagon.

FIG. 5C is a diagram illustrating an example where a gate electrode 20 of an ionizer 1 according to various embodiments is hexagonal.

Referring to FIG. 5C, the gate electrode 20 may be formed in a regular hexagon. In other words, the gate electrode 20 may include an outer surface of a regular hexagonal shape and an inner surface of a regular hexagonal shape. Accordingly, a space of a regular hexagonal shape may be formed inside the gate electrode 20. The carbon brush 10 may be disposed at the center of the gate electrode 20 formed in a regular hexagonal shape. The gate electrode 20 may be disposed to be positioned at the same height as or lower than the upper end of the carbon brush 10. In other words, the upper end of the carbon brush 10 may be disposed to be positioned at the same height as or higher than the upper surface of the gate electrode 20.

In an embodiment, as illustrated in FIG. 2, the gate electrode 20 may be disposed so as to be positioned lower than the upper end of the carbon brush 10. In other words, a step may exist between the gate electrode 20 and the carbon brush 10.

In this case, the height h of the step, for example, the distance between the tip of the carbon brush 10 and the upper surface of the gate electrode 20, may be at most 50 mm.

The height h of the step, for example, the distance between the tip of the carbon brush 10 and the upper surface of the gate electrode 20, may be V₀/3000 mm to 20×V₀/3000 mm.

V₀ is the voltage applied to the carbon brush 10 or the gate electrode 20, and 3000 is the insulation breakdown strength of air. The unit of the insulation breakdown strength of air is V/mm.

When the height of the step is too large, it may be impossible to prevent or avoid the carbon brush 10 from being contaminated.

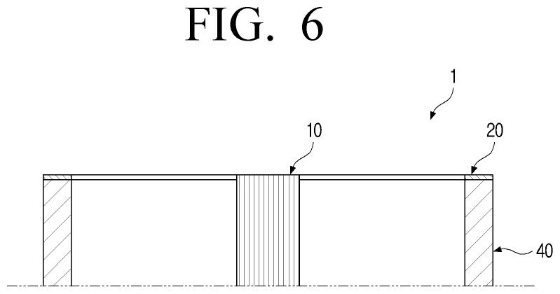

FIG. 6 is a partial cross-sectional view illustrating an ionizer according to various embodiments.

As another example, as illustrated in FIG. 6, the gate electrode 20 may be disposed to be positioned at the same height as the carbon brush 10. In other words, the upper surface of the gate electrode 20 and the tip of the carbon brush 10 may be positioned at the same height. In this case, the upper surface of the gate electrode 20 and the tip of the carbon brush 10 may be positioned on the same plane.

Referring again to FIGS. 1 to 3, the gate electrode 20 may be supported by a gate support 40. The gate support 40 may support the gate electrode 20, and may be provided on the outside of the brush support 30. The gate electrode 20 may be disposed at the tip of the gate support 40.

The gate support 40 may be formed to surround the carbon brush 10. The gate support 40 may surround the brush support 30 and the carbon brush 10 protruding from the upper end of the brush support 30.

The gate support 40 may be positioned at a height slightly lower than the tip of the carbon brush 10 so that the gate electrode 20 may be positioned at the same height as the tip of the carbon brush 10 or at a height slightly lower than the tip of the carbon brush 10. Accordingly, the gate support 40 may surround most of the carbon brush 10. As a result, the gate support 40 may prevent and/or reduce the carbon brush 10 from being contaminated by contaminants such as dust.

The gate support 40 may be formed in a shape corresponding to the gate electrode 20. In detail, the cross-section of the gate support 40 may be formed in a shape corresponding to the gate electrode 20.

For example, when the gate electrode 20 is formed in a ring shape, the gate support 40 may be formed in a hollow cylindrical shape.

As another example, when the gate electrode 20 is formed in a regular polygonal shape, the gate support 40 may be formed in a barrel shape with a regular polygonal cross-section. For example, the gate support 40 may be formed in a regular triangular barrel, a square barrel, a regular pentagonal barrel, or a regular hexagonal barrel with an empty interior.

The space between the brush support 30 and the gate support 40 may be blocked. For example, the space between the lower end of the brush support 30 and the lower end of the gate support 40 may be blocked. In other words, the brush support 30 may be disposed on the lower surface of the gate support 40 that blocks the bottom of the gate support 40.

However, the ionizer 1 according to the disclosure may not be limited thereto. As another example, the space between the lower end of the brush support 30 and the lower end of the gate support 40 may be open.

The power supply 50 may be electrically connected to the carbon brush 10 and the gate electrode 20. For example, when the power supply 50 is electrically connected to the carbon brush 10, the gate electrode 20 may be electrically connected to a ground 55. Alternatively, when the power supply 50 is electrically connected to the gate electrode 20, the carbon brush 10 may be electrically connected to the ground 55.

As illustrated in FIG. 2, the ionizer 1 according to various embodiments may have the gate electrode 20 connected to the power supply 50 and the carbon brush 10 connected to the ground 55.

The gate electrode 20 and the power supply 50 may be connected by a first wire 51. The first wire 51 may be connected to the power supply 50 through the inner space of the gate support 40.

However, the arrangement of the first wire 51 connecting the power supply 50 and the gate electrode 20 may not be limited thereto. The first wire 51 may be disposed on the outer surface of the gate support 40. The first wire 51 may be disposed to pass through the gate support 40.

The carbon brush 10 may be connected to the ground 55 by a second wire 52. The second wire 52 may be connected to the ground 55 by penetrating the lower surface of the gate support 40.

The power supply 50 may be configured to apply a high voltage to the carbon brush 10 or the gate electrode 20. For example, the power supply 50 may be configured to apply a voltage of 8500 V to the carbon brush 10 or the gate electrode 20.

The power supply 50 may be electrically connected to a processor 60. The processor 60 may be configured to control the power supply 50 to apply power to the carbon brush 10 or the gate electrode 20. The processor 60 may include various processing circuitry and be configured to control the magnitude and application time of the voltage applied by the power supply 50 to the carbon brush 10 or the gate electrode 20. The processor 60 may be configured to control the power supply 50 to adjust the strength and duration of the electric field generated between the carbon brush 10 and the gate electrode 20.

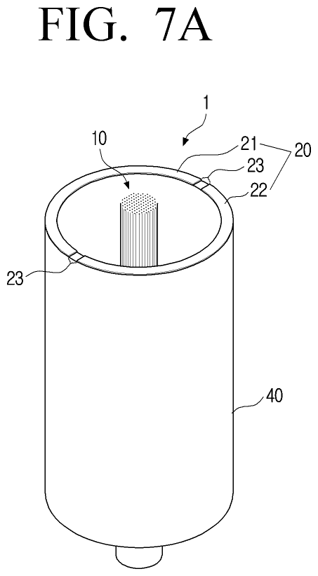

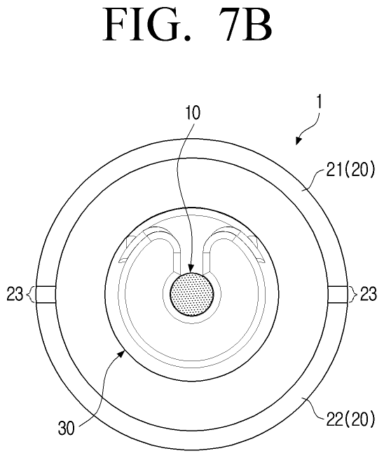

In the above, the case where the gate electrode 20 is formed as a closed loop is illustrated and described, but the shape of the gate electrode 20 used in the ionizer 1 according to the disclosure may not be limited thereto. As another example, as illustrated and described in greater detail below with reference to FIGS. 7A and 7B, the gate electrode 20 may be formed in a segmented manner.

FIG. 7A is a partial perspective view illustrating an ionizer 1 according to various embodiments having a plurality of gate electrodes 20. FIG. 7B is a diagram illustrating a plan view of the ionizer 1 of FIG. 7A.

Referring to FIGS. 7A and 7B, an ionizer 1 according to various embodiments may include a carbon brush 10 and a gate electrode 20.

The carbon brush 10 may be configured to emit ions from the tip thereof. The carbon brush 10 may be formed of a plurality of carbon fiber strands 11. In other words, the carbon brush 10 may be formed of the plurality of carbon fiber strands 11 in a bundle shape. The plurality of carbon fiber strands 11 may be arranged in a circular shape. The plurality of carbon fiber strands 11 may be spaced apart from each other by a certain distance so as not to come into contact with each other.

The carbon brush 10 may be supported by a brush support 30. The carbon brush 10 may be disposed on the upper end of the brush support 30. A portion of the carbon brush 10 may be accommodated in a receiving recess 31 provided inside the brush support 30, and the remaining portion of the carbon brush 10 may protrude upward from the upper end of the brush support 30.

The brush support 30 may be configured to fix and support the carbon brush 10. The brush support 30 may be formed in an approximately cylindrical shape or an approximately truncated cone shape. The receiving recess 31 in which the carbon brush 10 is accommodated may be provided on the outer circumferential surface of the brush support 30.

The gate electrode 20 may be disposed around the carbon brush 10. The gate electrode 20 may be configured to enhance an ion emission effect by strengthening the electric field applied to the carbon brush 10.

The gate electrode 20 may include a plurality of gate electrode parts 21 and 22. The plurality of gate electrode parts 21 and 22 may be arranged at the same distance from the carbon brush 10. For example, the plurality of gate electrode parts 21 and 22 may be arranged in a circular shape from the carbon brush 10.

In an embodiment, the gate electrode 20 may include two gate electrode parts 21 and 22. The two gate electrode parts 21 and 22 may be formed in an approximately semicircular shape. The two gate electrode parts 21 and 22 may be formed in the same shape.

The two gate electrode parts 21 and 22 may be spaced apart from each other by a certain distance. In other words, a certain gap 23 may exist between two adjacent gate electrode parts 21 and 22. The gaps 23 between the two gate electrode parts 21 and 22 may be formed to be the same.

In an embodiment, the gate electrode 20 includes two gate electrode parts 21 and 22, but the gate electrode 20 according to the disclosure is not limited thereto. As another example, the gate electrode 20 may include three or more gate electrode parts. In this case, the gaps between the three or more gate electrode parts may be arranged in the same manner.

In other words, the gate electrode 20 according to one or more embodiments of the disclosure may include the plurality of gate electrode parts 21 and 22, and the gaps 23 between the plurality of gate electrode parts 21 and 22 may be formed identically.

The gaps 23 between the plurality of gate electrode parts 21 and 22 may be arranged symmetrically with respect to the carbon brush 10. When the plurality of gaps 23 between the plurality of gate electrode parts 21 and 22 are arranged symmetrically, the electric field generated between the carbon brush 10 and the plurality of gate electrode parts 21 and 22 may be prevented/inhibited from being deflected.

In this example, the plurality of gate electrode parts 21 and 22 are arranged in a circular shape, but the arrangement of the plurality of gate electrode parts 21 and 22 forming the gate electrode 20 is not limited thereto. As another example, the plurality of gate electrode parts 21 and 22 according to the disclosure may be arranged in a regular polygonal shape.

The gate electrode 20 may be disposed to be positioned at the same height as or lower than the upper end of the carbon brush 10. In other words, the upper end of the carbon brush 10 may be disposed to be positioned at the same height as or higher than the upper surface of the gate electrode 20. Because the height relationship between the gate electrode 20 and the carbon brush 10 is the same as that of the ionizer 1 according to the above-described embodiment, a detailed description thereof may not be repeated here.

The gate electrode 20 may be supported by a gate support 40. The gate support 40 may support the gate electrode 20, and may be provided on the outside of the brush support 30. The gate electrode 20 may be disposed at the tip of the gate support 40.

The gate support 40 may be formed to surround the carbon brush 10. The gate support 40 may surround the brush support 30 and the carbon brush 10 protruding from the upper end of the brush support 30. Because the gate support 40 is the same as that of the ionizer 1 according to the above-described embodiment, a detailed description thereof may not be repeated here.

The gate electrode 20 may be electrically connected to a power supply 50, and the carbon brush 10 may be electrically connected to a ground 55. Accordingly, when the power supply 50 applies a high voltage to the gate electrode 20, an electric field may be generated between the gate electrode 20 and the carbon brush 10. Because the power supply 50 is the same as that of the ionizer 1 according to the above-described embodiment, a detailed description thereof may not be repeated here.

In order to compare the effect of the ionizer 1 according to various embodiments having the above structure with the ionizer according to the prior art, a computer simulation was performed.

The computer simulation was performed using COMSOL MULTIPHISICS™ software.

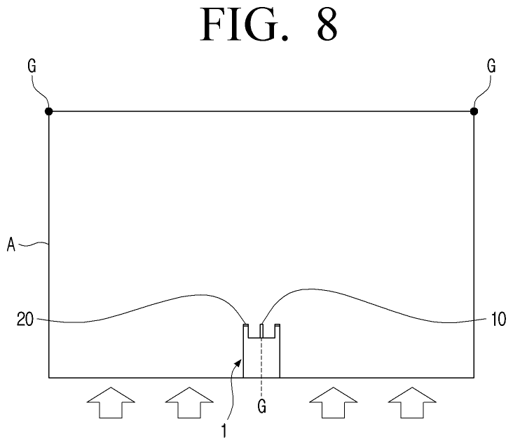

The conditions of the computer simulation are illustrated and described in greater detail below with reference to FIG. 8.

FIG. 8 is a diagram illustrating electric field and flow analysis conditions of an ionizer 1 according to various embodiments.

Referring to FIG. 8, the ionizer 1 is placed on the lower surface of the analysis area A. the analysis area A is formed in a rectangular shape. It is assumed that air flows from the bottom to the top of the analysis area A (see arrow). The speed of the air flow is 1.4 m/s. A voltage of +8500 V is applied to the gate electrode 20. The ground G is provided at both corners of the upper surface of the analysis area A. In addition, the carbon brush 10 of the ionizer 1 is also connected to the ground G.

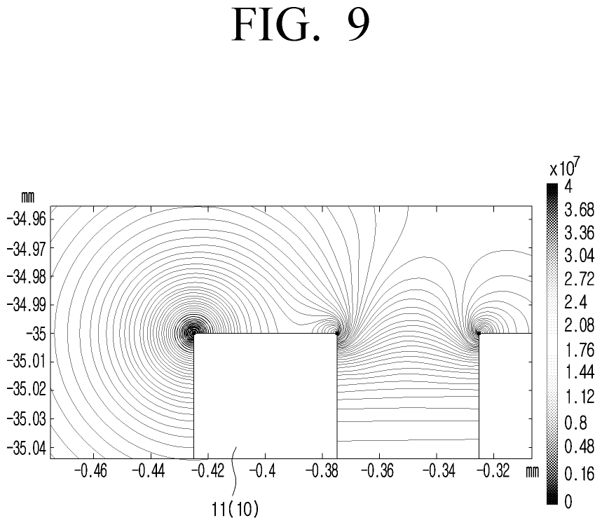

When the voltage is applied to the gate electrode 20 of the ionizer 1, an electric field is generated in the carbon brush 10. An example of the electric field generated in the carbon brush 10 is illustrated and described in greater detail below with reference to FIG. 9.

FIG. 9 is a diagram illustrating an electric field distribution around a carbon brush strand 11 of an ionizer 1 according to various embodiments.

Referring to FIG. 9, the ionizer 1 according to various embodiments may have an electric field of 1×10⁷ V/m to 4×10⁷ V/m distributed around the carbon fiber strand 11. The electric field may be formed around the corner of the tip of the carbon fiber strand 11.

However, the ionizer according to the prior art has an electric field of 2×10⁶ V/m to 8×10⁶ V/m distributed around the carbon fiber strand 11.

From this, it can be seen that the ionizer 1 according to various embodiments forms the electric field of stronger intensity than the ionizer according to the prior art when the same voltage is applied. The strong electric field may improve the ion emission performance of the ionizer 1 and increase the ionization rate.

Therefore, the ionizer 1 according to various embodiments may lower the intensity of the applied voltage in order to achieve the same ionization rate and ion emission performance as the ionizer according to the prior art. In other words, the ionizer 1 according to various embodiments may reduce power consumption.

This effect may be caused by the gate electrode 20 arranged adjacent to the carbon brush 10.

The ionizer according to the prior art refers to the case where the gate electrode 20 and the gate support 40 are removed from the ionizer 1 according to one or more embodiments of the disclosure. In other words, the ionizer according to the prior art includes only the carbon brush 10 and the brush support 30.

When performing the computer simulation for the ionizer according to the prior art, the analysis area A where the ionizer is disposed is the same as in FIG. 8. However, the grounds G are provided only at both corners of the upper surface of the analysis area A. In addition, a voltage of −8500 V is applied to the carbon brush 10.

In addition, a computer simulation was performed to analyze the influence of the surface charge of the surrounding structure on the ionizer 1 according to various embodiments.

To this end, the surface charge density of the upper surface of the analysis area A was set to various conditions, and the change in the electric field of the carbon fiber strand 11 of the carbon brush 10 of the ionizer 1 was checked.

The surface charge density of the analysis area A was set to five conditions, that is, zero (0), −1×10⁻⁷ C/m², −2×10⁻⁷ C/m², −1×10⁻⁶ C/m², −1×10⁻⁵ C/m². As a result of the computer simulation, when the surface charge density changed from zero (0) to −1×10⁻⁶ C/m², the electric field distribution of the carbon brush 10 did not change. In addition, the electric field change amount in the vertical axis (y-axis) direction was constant.

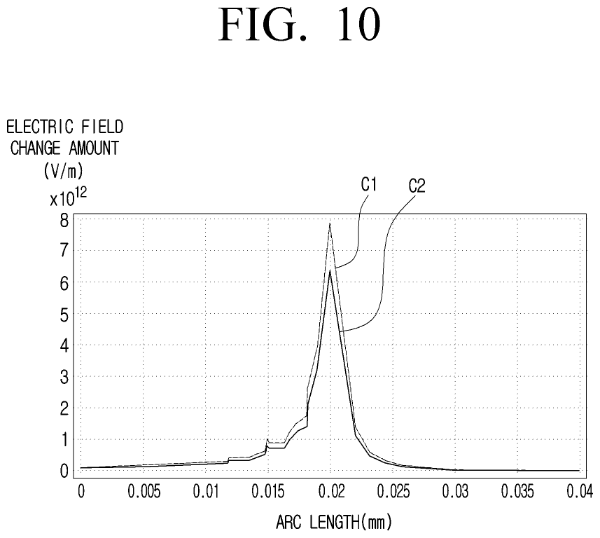

FIG. 10 is a graph illustrating the electric field change amount in the vertical axis direction around a carbon brush 10 of an ionizer 1 according to various embodiments depending on the surface charge density.

In FIG. 10, C1 represents the electric field change amount in the vertical axis direction when the surface charge density is zero (0), −1×10⁻⁷ C/m², −2×10⁻⁷ C/m², and −1×10⁻⁶ C/m². In this case, the electric field change amount is maximum when the arc length is 0.02 mm regardless of the change in the surface charge density. At this time, the electric field change amount is approximately 7.9×10¹² V/m.

When the surface charge density is −1×10⁻⁵ C/m², the distribution of the electric field of the carbon brush 10 changed. In this case, the electric field change amount in the vertical axis direction also changed. In FIG. 10, C2 represents the electric field change amount in the vertical axis direction when the surface charge density is −1×10⁻⁵ C/m². In the case that the surface charge density is −1×10⁻⁵ C/m², the electric field change amount is approximately 6.4×10¹² V/m when the arc length is 0.02 mm. From this, it can be seen that the electric field change amount in the vertical axis direction is reduced when the surface charge density is −1×10⁻⁵ C/m² compared to when the surface charge density is zero (0), −1×10⁻⁷ C/m², −2×10⁻⁷ C/m², and −1×10⁻⁶ C/m². In other words, in the case of one or more embodiments of the disclosure, the surface charge density causing the change in the electric field distribution may be −1×10⁻⁵ C/m².

A computer simulation was performed on the electric field change according to the change in the surface charge density under the analysis conditions of FIG. 8 for the ionizer according to the prior art.

The surface charge density of the analysis area A was set to three conditions, that is, zero (0), −1×10⁻⁷ C/m², and −2×10⁻⁷ C/m².

As a result of the computer simulation, when the surface charge density changed from zero (0) to −2×10⁻⁷ C/m², the electric field intensity of the carbon brush 10 decreased from a range of about 2×10⁶ V/m to about 8×10⁶ V/m to a range of about 0.5×10⁶ V/m to about 4×10⁶ V/m. In addition, the electric field change amount in the vertical axis (y-axis) direction also changed.

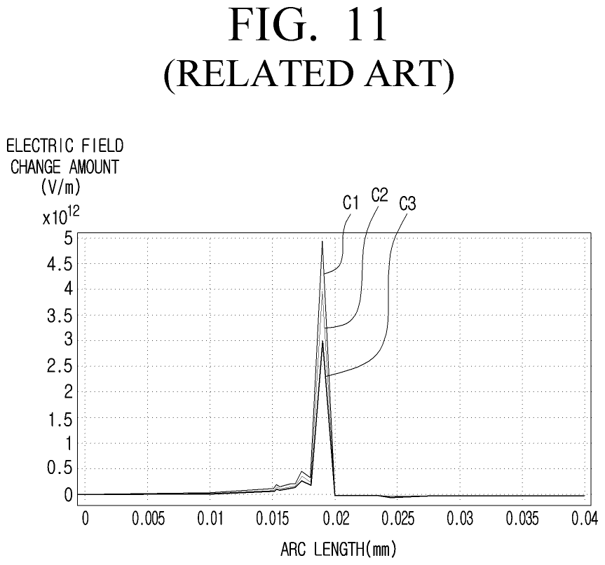

FIG. 11 is a graph illustrating the electric field change amount in the vertical axis direction around a carbon brush 10 of an ionizer according to the prior art depending on the surface charge density.

In FIG. 11, C1 represents the electric field change amount in the vertical axis direction when the surface charge density is zero (0), C2 represents the electric field change amount in the vertical axis direction when the surface charge density is-1×10⁻⁷ C/m², and C3 represents the electric field change amount in the vertical axis direction when the surface charge density is −2×10⁻⁷ C/m². In this case, the electric field change amount is maximum when the arc length is 0.019 mm regardless of the change in the surface charge density.

When the surface charge density is zero (0), the electric field change amount in the vertical axis direction is approximately 5×10¹² V/m. When the surface charge density is −1×10⁻⁷ C/m², the electric field change amount in the vertical axis direction is approximately 4×10¹² V/m. When the surface charge density is −2×10⁻⁷ C/m², the electric field change amount in the vertical axis direction is approximately 3×10¹² V/m.

From the above results, it can be seen that in the ionizer according to the prior art, when the surface charge density is −1×10⁻⁷ C/m², the electric field distribution of the carbon brush 10 changes.

Therefore, in the ionizer according to the prior art, when the surface charge density increases slightly, the intensity of the electric field may be greatly reduced. Accordingly, when the ionizer according to the prior art is used, charges accumulated in the surrounding structure may adversely affect the ion emission and diffusion performance of the ionizer.

However, in the ionizer 1 according to various embodiments of the disclosure, the electric field distribution of the carbon brush 10 may not change until the surface charge density is −1×10⁻⁶ C/m², and the electric field distribution may change when the surface charge density is −1×10⁻⁵° C./m².

Thus, in the ionizer 1 according to various embodiments, the surface charge density capable of causing a change in the electric field distribution may be −1×10⁻⁵ C/m², while in the ionizer according to the prior art, the surface charge density capable of causing a change in the electric field distribution may be −1×10⁻⁷ C/m². Therefore, the surface charge density capable of causing a change in the electric field distribution may be about 100 times higher in the ionizer 1 according to one or more embodiments of the disclosure than in the ionizer according to the prior art.

Therefore, compared to the ionizer according to the prior art, the ionizer 1 according to various embodiments of the disclosure may continuously exhibit ion emission and diffusion performance without being affected by charges accumulated in the surrounding structure.

From the above results, it can be seen that in the ionizer according to the prior art, when the surface charge density increases slightly, the intensity of the electric field is greatly reduced. Accordingly, when the ionizer according to the prior art is used, the charges accumulated in the surrounding structure may adversely affect the ion emission performance of the ionizer.

In addition, a computer simulation was performed to analyze the ion diffusion effect and contamination prevention/reduction effect of the carbon brush 10 depending on the positional relationship between the gate electrode 20 and the carbon brush 10 of the ionizer 1 according to one or more embodiments of the disclosure.

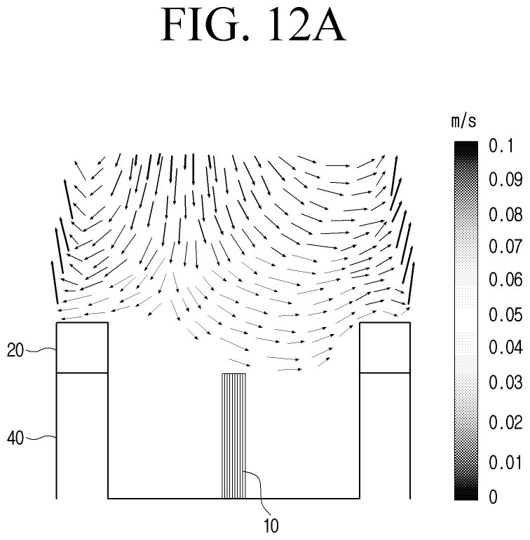

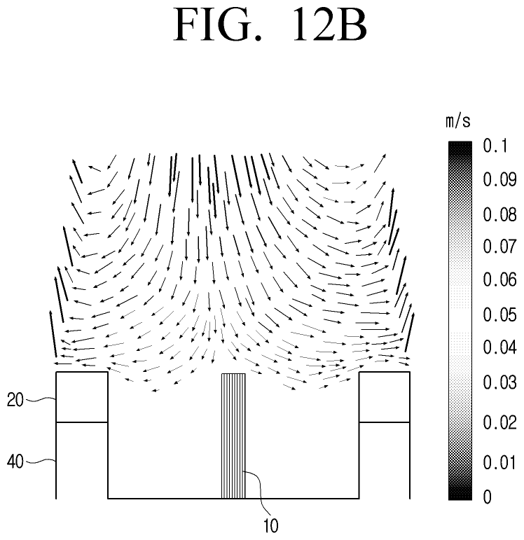

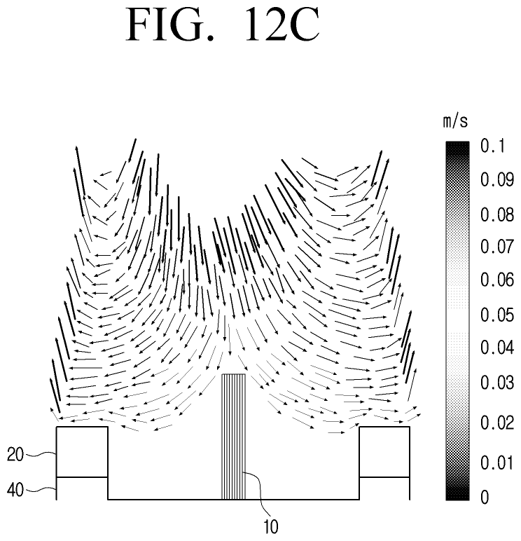

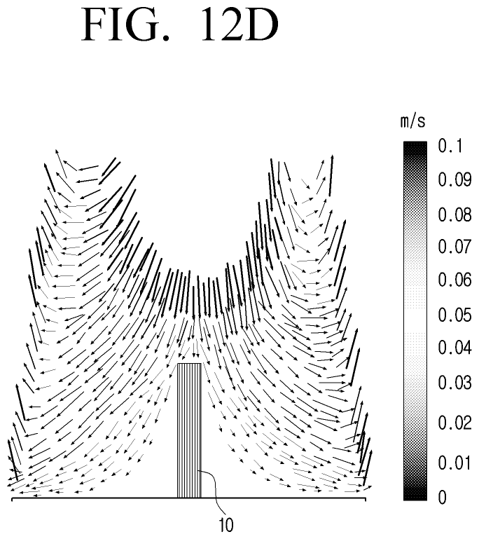

FIGS. 12A, 12B, 12C and 12D are diagrams illustrating the flow distribution around an ionizer 1 according to the positional relationship between a carbon brush 10 and a gate electrode 20 according to various embodiments.

FIGS. 12A, 12B, 12C and 12D (which may be referred to as FIGS. 12A to 12D) illustrate the flow distribution around the carbon brush 10 and the gate electrode 20 when the air flow flows from the lower side to the upper side of the ionizer 1 at a speed of 1.4 m/s. At this time, a low-speed flow of 0.1 m/s in the opposite direction to the main flow of 1.4 m/s is formed around the carbon brush 10.

FIG. 12A illustrates a case where the gate electrode 20 is positioned 2 mm higher than the carbon brush 10 around the carbon brush 10. Referring to FIG. 12A, the gate support 40 and the gate electrode 20 disposed on the upper end of the gate support 40 shield the air flow, so that there is almost no air flow around the carbon brush 10.

As illustrated in FIG. 12A, when the gate electrode 20 is positioned higher than the top of the carbon brush 10, the gate support 40 may block the contaminant particles contained in the air flow from attaching to the carbon brush 10, so that the contamination prevention/reduction effect may be the greatest, but the ion diffusion effect may be the lowest.

FIG. 12B illustrates a case where the gate electrode 20 is positioned at the same height as the carbon brush 10 around the carbon brush 10. In other words, in the case of FIG. 12B, the upper surface of the gate electrode 20 and the top of the carbon brush 10 are positioned on the same plane. Referring to FIG. 12B, a slow flow of 0.01 m/s to 0.03 m/s may exist in the horizontal direction around the top of the carbon brush 10.

As illustrated in FIG. 12B, when the gate electrode 20 and the carbon brush 10 are positioned at the same height, the contamination prevention/reduction effect may be smaller and the ion diffusion effect may be larger than in the case of FIG. 12A.

FIG. 12C illustrates a case where the gate electrode 20 is positioned 2 mm lower than the carbon brush 10 around the carbon brush 10. Referring to FIG. 12C, a slow flow of 0.01 m/s to 0.04 m/s may exist in the downward slope direction toward the gate electrode 20 around the top of the carbon brush 10.

As illustrated in FIG. 12C, when the gate electrode 20 is positioned lower than the top of the carbon brush 10, the contamination prevention/reduction effect may be smaller and the ion diffusion effect may be larger than in the case of FIG. 12B.

FIG. 12D illustrates a case where there are no gate electrode 20 and no gate support 40 supporting the gate electrode 20 around the carbon brush 10. In other words, FIG. 12D shows an ionizer according to the prior art. Referring to FIG. 12D, a fast air flow may be formed in a vertical direction around the carbon brush 10. Therefore, there is a high possibility that contaminant particles contained in the air flow may be attached to the carbon brush 10 by inertial force, causing contamination (e.g., impaction contamination).

When the gate electrode 20 and the gate support 40 do not exist around the carbon brush 10 as in FIG. 12D, there is no contamination prevention/reduction effect that can prevent and/or reduce contamination of the carbon brush 10. However, the ion diffusion effect may be greater than in the case of FIG. 12C.

Therefore, in the ionizer 1 according to various embodiments of the disclosure, the gate electrode 20 may be disposed at the same height as or lower than the top of the carbon brush 10 so as to obtain both the ion diffusion effect and the contamination prevention/reduction effect.

The ionizer 1 according to various embodiments of the disclosure having the structure as described above may increase the ion generating effect and prevent and/or reduce the ion generating and diffusion performance from being deteriorated by charges accumulated in a surrounding structure. In addition, the ionizer 1 according to various embodiments of the disclosure may reduce power consumption and prevent and/or reduce contamination of the carbon brush 10 to extend its lifespan.

Hereinafter, an air conditioner 100 including the ionizer 1 according to various embodiments of the disclosure will be described in greater detail.

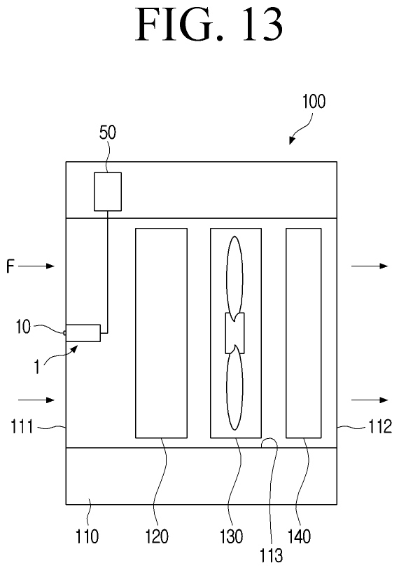

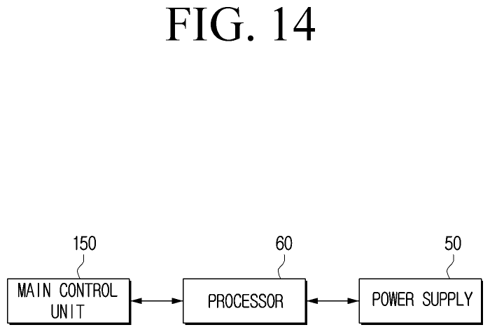

FIG. 13 is a diagram illustrating an air conditioner including an ionizer 1 according to various embodiments. FIG. 14 is a block diagram illustrating an example configuration of an air conditioner including an ionizer 1 according to various embodiments.

Referring to FIGS. 13 and 14, an air conditioner 100 according to various embodiments of the disclosure may include a main body 110, an ionizer 1, an air flow generating device 130, and a dust collector 120.

The main body 110 may form the outer shape of the air conditioner 100, and may be formed in various shapes depending on the type of the air conditioner 100. The air conditioner 100 may be any one of an air purifier, an air conditioning device, a dehumidifier, a humidifier, etc.

The main body 110 may include an air inlet 111 through which external air is sucked in, an air outlet 112 through which the sucked air is discharged, and an air passage 113 connecting the air inlet 111 and the air outlet 112.

The ionizer 1 may be disposed in the air inlet 111 of the main body 110, and may be configured to charge aerosols (e.g., contaminants such as dust) contained in the air sucked in through the air inlet 111 using a plurality of carbon fiber strands 11. Because the ionizer 1 has been described above, a detailed description thereof may not be repeated here.

The ionizer 1 may be disposed parallel to the air flow. For example, the ionizer 1 may be disposed so that the carbon brush 10 is parallel to the air flow that flows into the air inlet 111 of the main body 110.

The ionizer 1 may be electrically connected to a power supply 50. When the power supply 50 applies a high voltage to the ionizer 1, ions may be generated from the carbon brush 10.

A processor 60 may be configured to control the magnitude and application time of the voltage applied to the ionizer 1 by the power supply 50.

The processor 60 may be electrically connected to a main control unit 150. The main control unit 150 may include various circuitry and be configured to control the air conditioner 100. The processor 60 may be configured as a part of the main control unit 150. The main control unit 150 may include an input unit for controlling the air conditioner 100.

The air flow generating device 130 may be disposed inside the main body 110, and may be configured to form an air flow in which external air containing aerosol is introduced into the air inlet 111 and discharged to the outside of the main body 110 through the air outlet 112. In other words, when the air flow generating device 130 operates, air containing aerosol may be introduced into the air inlet 111 of the main body 110, flow along the air passage 113, and be discharged to the outside through the air outlet 112. A fan capable of generating suction power to suck in air may be used as the air flow generating device 130.

The dust collector 120 may be disposed in the air passage 113 provided inside the main body 110, and may be configured to collect the aerosols charged by the ionizer 1 from the air sucked in by the air flow generating device 130.

For example, the dust collector 120 may include a plurality of dust collecting plates (not illustrated) spaced apart from each other by a certain distance and a dust collecting voltage applying part (not illustrated) that applies a high voltage to the plurality of dust collecting plates. When a high voltage is applied to the plurality of dust collecting plates by the dust collecting voltage applying part, the aerosols that are charged by combining with the ions generated from the ionizer 1 may be collected on the plurality of dust collecting plates. Therefore, because the aerosols included in the sucked external air are removed by the dust collector 120, the dust collector 120 may discharge the cleaned air.

The above-described ionizer 1, dust collector 120, and air flow generating device 130 may configure an electrostatic dust collector.

The main body 110 may further include a treatment device 140 configured to perform a certain treatment on the sucked air.

For example, when the air conditioner 100 is implemented as an indoor unit of the air conditioner, a heat exchanger configured to exchange heat with the sucked air may be provided in the main body 110 as the treatment device 140. When the air conditioner 100 is a dehumidifier, a dehumidifying device configured to remove moisture from the sucked air may be provided in the main body 110 as the treatment device 140. In addition, when the air conditioner 100 is a humidifier, a humidifying device configured to add moisture to the sucked air may be provided in the main body 110 as the treatment device 140. On the other hand, when the air conditioner 100 is an air purifier using the ionizer 1 according to one or more embodiments of the disclosure, the treatment device 140 may not exist inside the main body 110.

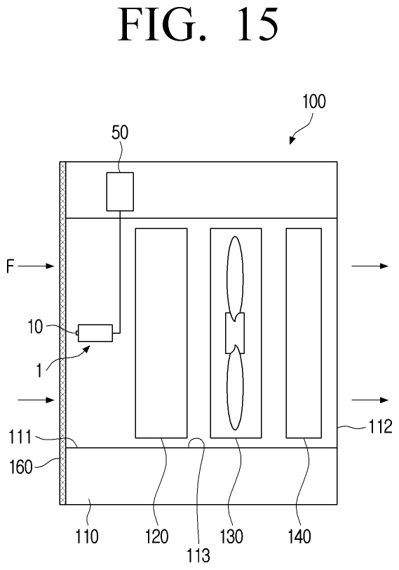

As another example, a filter 160 may be disposed on the front side of the main body as illustrated an described in greater detail below with reference to FIG. 15.

FIG. 15 is a diagram illustrating an air conditioner including an ionizer 1 according to various embodiments.

Referring to FIG. 15, external air may pass through the filter 160 and flow into the air inlet 111 of the main body 110.

The ionizer 1 according to various embodiments may be disposed on the back side of the filter 160. The ionizer 1 may charge aerosols contained in the air passing through the filter 160.

Unlike the ionizer according to the prior art, the ionizer 1 according to various embodiments may not have the ion generating and diffusion performance deteriorated by charges accumulated in the surrounding structure. Therefore, the ionizer 1 according to one or more embodiments of the disclosure may maintain the ion generating and diffusion performance when the filter 160 is disposed in front of the ionizer 1.

The introduced air may pass through the dust collector 120, the air flow generating device 130, and the treatment device 140, and then be discharged to the outside of the main body 110 through the air outlet 112.

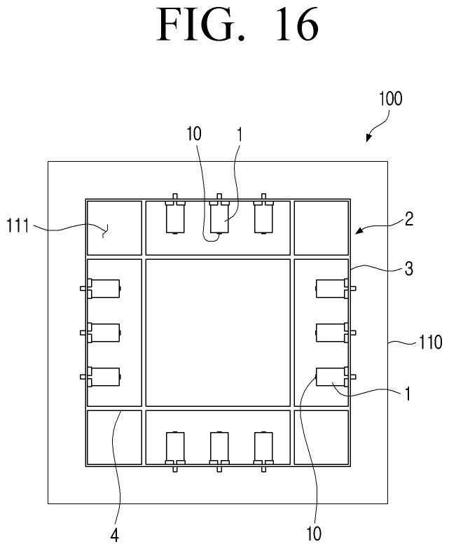

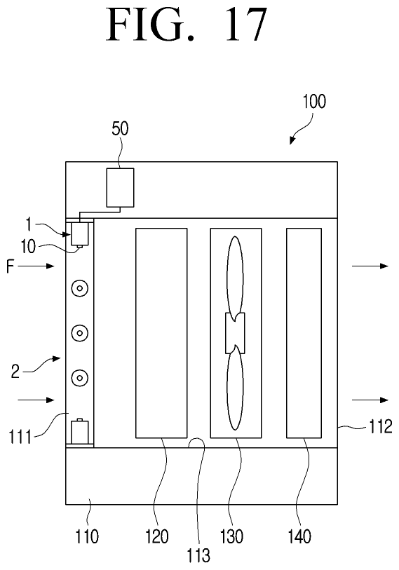

In the above, the case where one ionizer 1 is disposed in the main body 110 has been described. However, as another example, as illustrated and described in greater detail below with reference to FIGS. 16 and 17, a plurality of ionizers 1 may be disposed in the air inlet 111 of the main body 110.

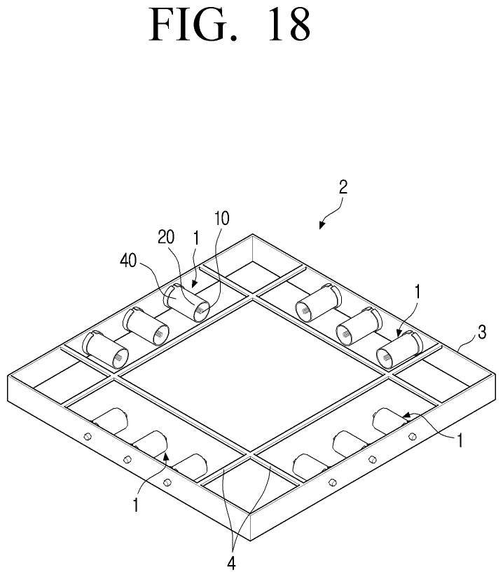

FIG. 16 is a diagram illustrating a front view of an air conditioner including an ionizer 1 according to various embodiments. FIG. 17 is a cross-sectional view illustrating the air conditioner of FIG. 16 according to various embodiments. FIG. 18 is a perspective view illustrating an ionizer unit of the air conditioner of FIG. 16 according to various embodiments.

Referring to FIGS. 16 and 17, an air conditioner 100 according to various embodiments may include a main body 110, an ionizer unit 2, an air flow generating device 130, and a dust collector 120.

The main body 110 may form the outer shape of the air conditioner 100, and may be formed in various shapes depending on the type of the air conditioner 100. The air conditioner 100 may be any one of an air purifier, an air conditioning device, a dehumidifier, a humidifier, etc.

The main body 110 may include an air inlet 111 through which external air is sucked in, an air outlet 112 through which the sucked air is discharged, and an air passage 113 connecting the air inlet 111 and the air outlet 112.

The ionizer unit 2 may be disposed in the air inlet 111 of the main body 110. Referring to FIGS. 16 and 18, the ionizer unit 2 may include a plurality of ionizers 1 and a frame 3 supporting the plurality of ionizers 1.

Each of the plurality of ionizers 1 may be configured to charge aerosols contained in air being sucked into the air inlet 111. Because the ionizer 1 has been described above, a detailed description thereof may not be repeated here.

Each of the plurality of ionizers 1 may be disposed perpendicular to the air flow. For example, the ionizer 1 may be disposed so that the carbon brush 10 is approximately perpendicular to the direction of air flow flowing into the air inlet 111 of the main body 110. However, the arrangement of the ionizer 1 with respect to the direction of the air flow is not limited thereto. As long as the ionizer 1 can charge aerosols contained in the air flow, the ionizer 1 may be arranged inclinedly at a certain angle with respect to the direction of the air flow.

The frame 3 may be formed in a rectangular shape. The plurality of ionizers 1 may be disposed at regular intervals on the inner surface of the frame 3. In an embodiment, three ionizers 1 may be disposed on the inner surfaces of the upper surface, lower surface, left side surface, and right side surface of the frame 3, respectively.

The frame 3 may include a plurality of reinforcing bars 4 for reinforcing the strength of the frame 3. The plurality of reinforcing bars 4 may be disposed inside the frame 3 so as to support the four side surfaces of the frame 3.

In the above, the case where the frame 3 of the ionizer unit 2 is rectangular and three ionizers 1 are disposed on each side surface of the frame 3 has been described. However, the shape of the frame 3 and the number of ionizers 1 disposed in the frame 3 are not limited thereto. The shape of the frame 3 and the number of ionizers 1 may be determined in various ways as long as the ionizer unit 2 can discharge ions to the entire air flowing in through the air inlet 111 of the main body 110 to charge the aerosols.

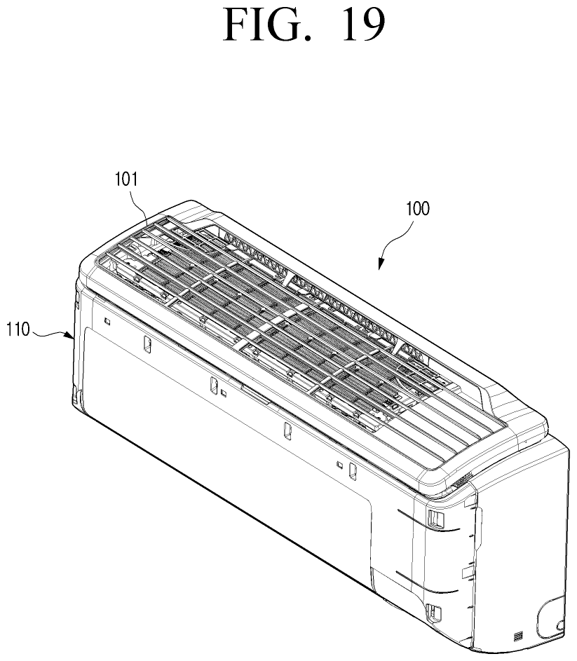

Hereinafter, an air conditioner including an ionizer 1 according to various embodiments of the disclosure will be described in greater detail with reference to FIGS. 19, 20 and 21 (which may be referred to as FIGS. 19 to 21).

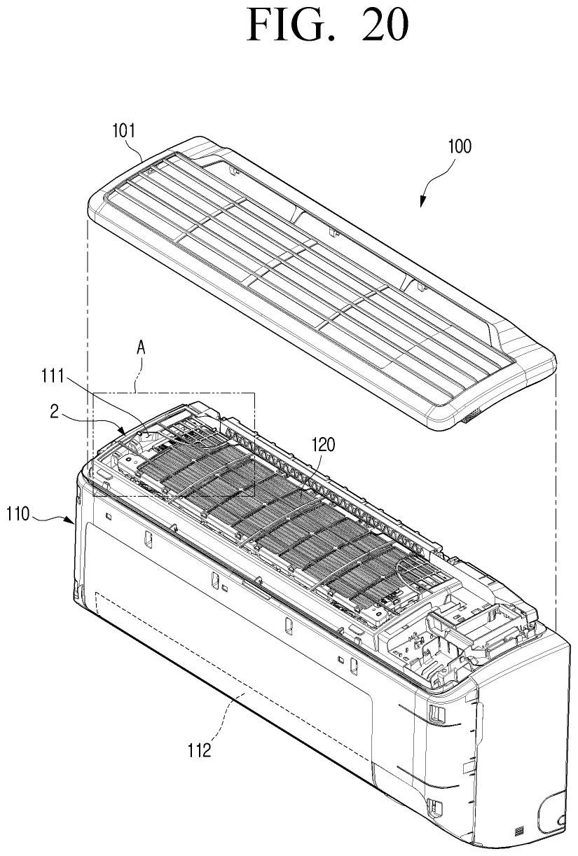

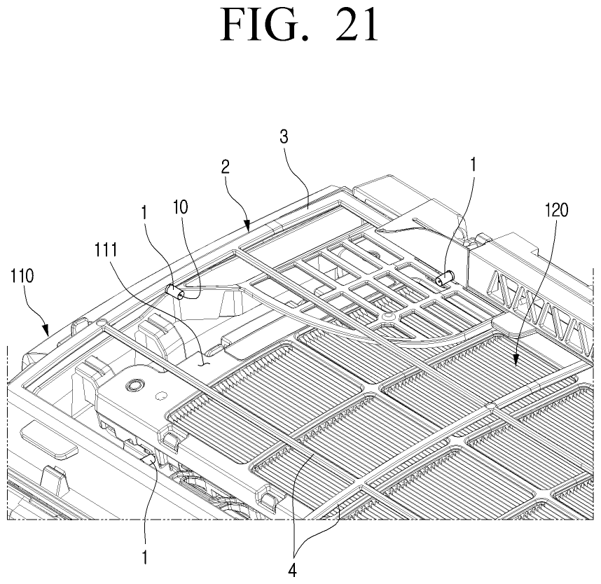

FIG. 19 is a perspective view illustrating an example indoor unit of an air conditioner according to various embodiments. FIG. 20 is a perspective view illustrating a state in which an upper grill is separated from the indoor unit of FIG. 19 according to various embodiments. FIG. 21 is an enlarged partial perspective view illustrating a portion A of FIG. 20 according to various embodiments.

Referring to FIGS. 19 to 21, the indoor unit 100 of an air conditioner may include a main body 110, an ionizer unit 2, a dust collector 120, an air flow generating device, and a heat exchanger.

The main body 110 may form the outer shape of the indoor unit 100. The main body 110 may be disposed on the wall of a room.

The main body 110 may include an air inlet 111 through which external air is sucked in, an air outlet 112 through which the sucked air is discharged, and an air passage 113 connecting the air inlet 111 and the air outlet 112.

The air inlet 111 may be provided on the upper surface of the main body 110. An upper grill 101 may be disposed in the air inlet 111. External air may be introduced into the air inlet 111 through the upper grill 101.

The air outlet 112 may be provided on the lower portion of the main body 110. An air flow adjuster configured to adjust the direction and intensity of air discharge may be disposed in the air outlet 112.

The ionizer unit 2 may be disposed in the air inlet 111 of the main body 110. The ionizer unit 2 may be disposed below the upper grill 101.

Referring to FIGS. 20 and 21, the ionizer unit 2 may include a plurality of ionizers 1 and a frame 3.

Each of the plurality of ionizers 1 may be configured to charge the aerosols contained in the air sucked into the air inlet 111. Because the ionizer 1 has been described above, a detailed description thereof may not be repeated here.

Each of the plurality of ionizers 1 may be disposed perpendicular to the air flow. In detail, the ionizer 1 may be disposed so that the carbon brush 10 is approximately perpendicular to the direction of the air flow flowing into the air inlet 111 of the main body 110.

The frame 3 may be configured to support the plurality of ionizers 1. The frame 3 may be formed in an approximately rectangular shape. The plurality of ionizers 1 may be disposed at regular intervals on the inner surface of the frame 3.

The frame 3 may include a plurality of reinforcing bars 4 to reinforce the strength of the frame 3. The plurality of reinforcing bars 4 may be disposed inside the frame 3 so as to support the four side surfaces of the frame 3.

The dust collector 120 may be disposed at the lower side of the ionizer unit 2 in the air passage. The dust collector 120 may be configured to collect aerosols charged by the ionizer 1 from among the air sucked in by the air flow generating device.

The air flow generating device and the heat exchanger may be disposed in the air passage formed inside the main body 110.

The air flow generating device may be disposed in the air passage, and may allow external air to be introduced into the air inlet 111 and discharged to the outside of the main body 110 through the air outlet 112.

The heat exchanger may be configured to exchange heat with external air. For example, the heat exchanger may cool the external air by exchanging heat with the external air passing through the air passage.

Therefore, when the air flow generating device operates, external air may be introduced into the air inlet 111 of the indoor unit 100, pass through the heat exchanger, and then be discharged to the outside of the indoor unit 100 through the air outlet 112. Because the upper grill 101, the ionizer unit 2, and the dust collector 120 are disposed in the air inlet 111 of the indoor unit 100, aerosols contained in the external air flowing into the air inlet 111 by the air flow generating device may be ionized by the plurality of ionizers 1, and the ionized aerosols may be collected by the dust collector 120 disposed downstream of the ionizer unit 2.

The air from which aerosols such as dust have been removed by the dust collector 120 may pass through the heat exchanger and then be discharged to the outside of the indoor unit 100 through the air outlet 112.

In the foregoing, the disclosure has been illustrated and described with reference to various example embodiments. However, it is understood by those skilled in the art that various changes may be made in form and detail without departing from the scope of the disclosure including the appended claims and equivalents thereof.

What is claimed is:

1. An ionizer comprising:
a carbon brush;
a gate electrode disposed about the carbon brush;
a power supply electrically connected to the carbon brush and the gate electrode; and
at least one processor, comprising processing circuitry, individually and/or collectively, configured to control the power supply to apply power to the carbon brush or the gate electrode,
wherein the gate electrode is disposed at a same height as or lower than an upper end of the carbon brush.

2. The ionizer of claim 1, wherein
the carbon brush is disposed at a center of the gate electrode, and
the gate electrode is formed as a closed loop.

3. The ionizer of claim 2, wherein
the gate electrode is formed in a ring shape or a regular polygonal shape.

4. The ionizer of claim 1, wherein
the gate electrode includes a plurality of gate electrodes surrounding the carbon brush, and
gaps between the plurality of gate electrodes are the same.

5. The ionizer of claim 1 further comprising:
a brush support configured to support the carbon brush; and
a gate support configured to support the gate electrode and provided on an outside of the brush support.

6. The ionizer of claim 5, wherein
the gate electrode is provided at a top of the gate support.

7. The ionizer of claim 5, wherein
a space between the brush support and the gate support is blocked.

8. The ionizer of claim 1, wherein
a distance between a tip of the carbon brush and an upper surface of the gate electrode is less than or equal to 50 mm.

9. The ionizer of claim 1, wherein
a distance between a tip of the carbon brush and an upper surface of the gate electrode is V₀/3000 to 20×V₀/3000,
where, V₀ is a voltage applied to the carbon brush or the gate electrode.

10. The ionizer of claim 1, wherein
the gate electrode has a rectangular cross-section, and
a width of the gate electrode is 0.1 mm to 10 mm, and a thickness of the gate electrode is 0.1 mm to 1 mm.

11. An air conditioner comprising:
a main body comprising an air inlet, an air outlet, and an air passage connecting the air inlet and the air outlet;
an ionizer according to claim 1 disposed in the air inlet;
a dust collector disposed in the air passage of the main body and configured to collect aerosols charged by the ionizer; and
an air flow generating device comprising a fan disposed in the air passage of the main body and configured to generate air flow through the air passage.

12. The air conditioner of claim 11, wherein
the ionizer comprises a plurality of ionizers arranged in the air inlet.

13. The air conditioner of claim 11, wherein
the ionizer is disposed so that the carbon brush is parallel to the air flow.

14. The air conditioner of claim 11, wherein
the ionizer is disposed so that the carbon brush is perpendicular to the air flow.

15. The air conditioner of claim 11, further comprising:
a treatment device comprising a dehumidifier disposed in the air passage of the main body.
